(19) United States
(12) Patent Application Publication
(10) Pub. No.: US 2026/0152279 A1
(43) Pub. Date: Jun. 4, 2026

(54) VEHICLE CONTROL COLUMN COMPRISING A LOCKING DEVICE

(71) Applicant: SAFRAN ELECTRONICS & DEFENSE, Paris (FR)

(72) Inventors: Yannick Ghislain Attrazic, Moissy-Cramayel (FR); Bruno Rongier, Moissy-Cramayel (FR)

(73) Assignee: SAFRAN ELECTRONICS & DEFENSE, Paris (FR)

(21) Appl. No.: 18/685,833

(22) PCT Filed: Sep. 6, 2022
(86) PCT No.: PCT/FR2022/051680

§ 371 Date: Feb. 22, 2024

(30) Foreign Application Priority Data
Sep. 9, 2021 (FR) FR2109462

(51) Int. Cl. B64C 13/04; G05G 5/00; G05G 9/047

(52) U.S. Cl. CPC B64C 13/0421; G05G 5/005; G05G 9/047

(57) ABSTRACT

A control stick for a vehicle comprising a control lever connected to a mechanical chain, a cup and a locking device, the control lever being oriented relative to a pivot point of the control stick, the locking device further comprising a frame, a lower jaw and an upper jaw which are movable between a locking position of the cup between the jaws and a free position, the lower jaw and the upper jaw being rigidly attached to the frame.

### TECHNICAL FIELD

The present invention relates to control devices used by aircraft pilots. Nevertheless, the present invention may be used in any type of land, sea, air or space vehicle.

More particularly, the present invention relates to an active control stick comprising an integral force feedback.

### PRIOR ART

The control device of an aircraft generally comprises a control stick comprising a control lever mounted in rotation along a so-called roll axis and a so-called pitch axis, these two axes being orthogonal.

The control stick transmits the movement commands to the control components of the aircraft, the movement commands being determined by the position of the control lever according to the two roll and pitch axes.

On recent control stick models, the movement commands are electronic fly-by-wire commands. The control stick is for example of the side stick type. The position of the control lever along the two roll and pitch axes is then measured by sensors and translated into electronic fly-by-wire commands by the computer of the aircraft for the control. Therefore, the control lever is not directly connected mechanically to the control components of the aircraft. The pilot does not feel any direct mechanical feedback.

A force feedback at the control lever is however desirable so that the pilot perceives the forces exerted at the controls. Control sensations are therefore improved if the control side stick integrates an active force feedback sometimes called haptic feedback.

Force feedback systems of the mechanical type exist, such as spring systems, or of the electromagnetic type, for example with a motor resolver.

Although the force feedback systems increase flight safety, they may be subject to electrical or mechanical failures. The pilot then no longer feels force feedback on the control lever, or even an anchoring point of the control lever. As the requirements in terms of aeronautical safety are important, it is not acceptable that the pilot abruptly passes from a nominal control mode to a control mode without force feedback.

To ensure a mechanical backup and prevent the control lever from moving freely, mechanical locking systems of the control lever have been developed so that the aircraft can be controlled in a backup control mode. Magneto-rheological brakes that can be electronically activated have for example been proposed in order to exert a resistive force countering the displacement of the control lever along the roll and pitch axes. The operation is based on locking the motor shafts using the brakes, the intention of the pilot being perceived by a force sensor placed at the base and in series with the control lever. During the control, the force applied by the pilot is transmitted to the computer of the aircraft instead of the position of the control lever.

Major drawbacks of this solution and other solutions of the prior art are the need for an additional power supply dedicated to the brakes, as well as the fact that these systems are generally complex, costly, bulky and unreliable, particularly in the case of a general power unavailability.

Finally, the nominal control mode and the backup control mode comprise a common breakdown mode. Indeed, these two control modes comprise the same mechanical force path between the control lever and the components that ensure the force feedback in nominal mode on the one hand, and between the control lever and the components that ensure the locking in backup control mode on the other hand. In the two nominal and backup control modes, a breakdown mode exists as regards the mechanical resistance of the mechanical chain between the control lever and the assembly comprising the motors, sensors and brakes, this breakdown mode adversely affecting the safety in the aircraft.

### DISCLOSURE OF THE INVENTION

Therefore, the aim of the present invention is to mitigate the aforementioned drawbacks and to propose a backup control mode that does not share a common breakdown mode with the nominal control mode in order to guarantee the safety of the aircraft.

The object of the present invention is a control stick for a vehicle, the control stick comprising a control lever connected to a mechanical chain, a cup and a locking device, the control lever extending from a pivot point of the control stick, the locking device comprising a frame, a lower jaw and an upper jaw which are movable between a locking position of the cup between the jaws and a free position, the lower jaw and the upper jaw being rigidly attached to the frame.

Thus, this device is advantageous because it makes it possible to lock the control stick while being independent of the rest of the mechanics of the system. Thus, the vehicle comprises a nominal control mode and a backup control mode with its force feedback and its specific force law, and that does not share a common breakdown mode, thus improving the safety. In addition, the device is compact, lightweight and reliable.

Advantageously, the cup is a sphere portion concentric to the pivot point and centred around the control lever.

Advantageously, the cup has a torsional flexibility and simulates a force law.

In one embodiment, the lower jaw and the upper jaw are annular sphere portions and comprise an opening intended to facilitate the displacement of the control lever when the jaws are in free position.

Advantageously, the cup and/or the jaws comprise a strongly adhering coating.

In one embodiment, the device comprises a mechanical actuator, actuating the jaws during a breakdown in the mechanical chain of the control stick.

Advantageously, the mechanical actuator comprises a spring and a means for releasing the spring, so that the jaws clamp the cup when the spring is released.

In another embodiment, the device comprises an electromagnetic actuator and a power supply of said electromagnetic actuator, the electromagnetic actuator actuating the jaws during a breakdown in the mechanical chain of the control stick.

Advantageously, the device comprises a force sensor placed in series with the control lever so that the intention of the pilot of the vehicle is acquired when the jaws are in position for locking the cup.

Another object of the invention is a vehicle comprising a control stick as defined above.

### BRIEF DESCRIPTION OF THE DRAWINGS

Other aims, features and advantages of the invention will become apparent upon reading the following description given only by way of non-limiting example, and made with reference to the appended drawings wherein:

FIG. 1 is a schematic view of a locking device for an aircraft control stick according to the invention in a free position and with the control stick in neutral position;

FIG. 2 is a schematic view of a locking device for an aircraft control stick according to the invention in a free position and with the control stick in inclined position;

FIG. 3 is a schematic view of a locking device for an aircraft control stick according to the invention in a locking position and with the control stick in neutral position; and

FIG. 4 is a schematic view of a locking device for an aircraft control stick according to the invention in a locking position and with the control stick in inclined position.

### DETAILED DESCRIPTION OF AT LEAST ONE EMBODIMENT

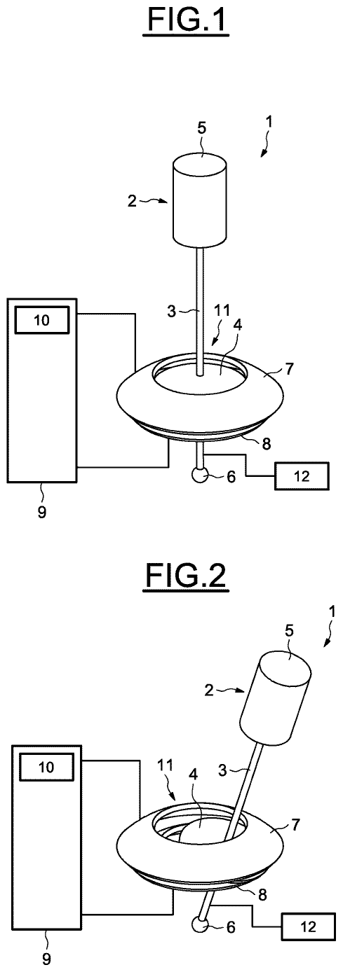

FIG. 1 shows a view of a locking device 1 for an aircraft control stick 2 in a free position.

The control stick 2 is for example an active side stick and comprises a control lever 3, a cup 4, and a handle 5. The control lever 3 is also connected to a mechanical chain (not shown) comprising motors, and/or sensors, and/or brakes needed to operate the control in a nominal control mode.

The control stick 2 further comprises a pivot point 6 corresponding to the point of rotation relative to which the control lever 3 is oriented during the control. In particular, the control lever 3 is orientable according to a first roll axis and according to a second pitch axis, the two axes being orthogonal with one another.

The control lever 3 is for example a cylindrical rod. The pivot point 6 and the handle 5 of the control stick 2 are for example each at one end of the control lever 3. The handle 5 is for example a grippable cylinder or may have any other shape suitable for gripping of the handle 5 by the pilot.

The cup 4 is positioned along the control lever 3. The cup 4 is for example a sphere portion concentric to the pivot point 6 and is centred around the control lever 3 so that the longitudinal axis of the control lever 3 passes through the centre of the cup 4.

In one embodiment, the cup 4 comprises a strongly adhering coating on its surface.

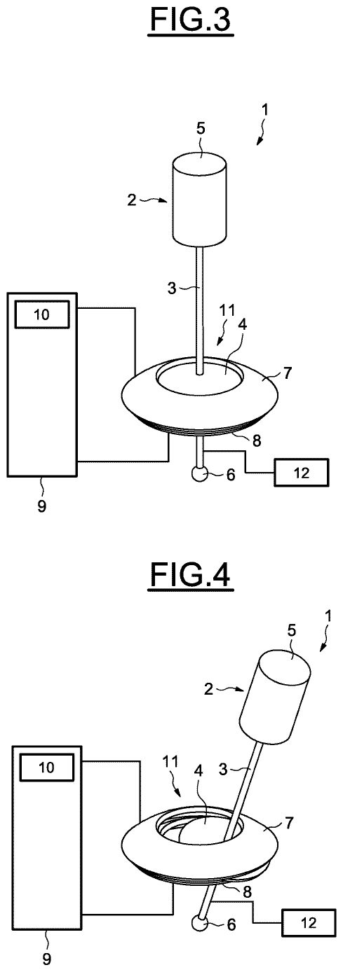

The locking device 1 comprises an upper jaw 7, a lower jaw 8 and a frame 9. The lower jaw 8 and the upper jaw 7 are positioned on either side of the cup 4 and are movable so that the lower jaw 8 and the upper jaw 7 can be moved closer to or apart from one another. In particular, the jaws 7 and 8 are movable between a free position illustrated in FIGS. 1 and 2, and a locking position of the cup 4 between the jaws 7 and 8 illustrated in FIGS. 3 and 4.

The lower jaw 8 and the upper jaw 7 are rigidly attached to the frame 9 that comprises a device for moving 10 the lower jaw 8 and the upper jaw 7.

In one embodiment, the lower jaw 8 and the upper jaw 7 are annular sphere portions. The sphere portions are concentric to the pivot point 6 in the free position. The lower jaw 8 and the upper jaw 7 each comprise a central opening 11 intended to facilitate the displacement of the control lever 3 when the jaws are in free position. In particular, the control lever 3 passes through openings 11 of the lower jaw 8 and the upper jaw 7 and the cup 4 is positioned between the lower jaw 8 and the upper jaw 7. As the cup 4 and both the lower jaw 8 and the upper jaw 7 are concentric with the pivot point 6 in the free position of FIGS. 1 and 2, the control stick 2 may be moved whereas the cup 4 moves between the lower jaw 8 and the upper jaw 7 as illustrated in FIG. 2. The angular displacement of the control lever 3 is approximately 40° between two extreme inclined positions.

The surface of the lower jaw 8 and the upper jaw 7 further comprises a strongly adhering coating. This coating makes it possible, while closing the jaws 7 and 8 in locking position, to guarantee the locking of the cup 4 between the two jaws 7 and 8.

In a particular embodiment of the invention, the control stick controls a third yaw axis orthogonal to the two roll and pitch axes that may also be blocked when the jaws 7 and 8 prevent the cup from rotating. For example, the blocking of this third yaw axis is performed by coupling in rotation about this yaw axis the jaws 7 and 8 and the cup 4. Additional splines between them extend for example radially over the surfaces of the jaws 7 and 8 and of the cup from the axis of the control lever 3.

The device for moving 10 the lower jaw 8 and the upper jaw 7 is for example a mechanical actuator. It comprises for example a spring and a means for releasing the spring (not shown), so that the lower jaw 8 and the upper jaw 7 clamp the cup 4 when the spring is released.

Alternatively, the device for moving the lower jaw 8 and the upper jaw 7 comprises an electromagnetic actuator and further comprises a power supply of said electromagnetic actuator (not shown).

Finally, the locking device 1 comprises a force sensor 12 placed in series at the base of the control lever 3 so that the pressing by the pilot of the aircraft on the control stick 2 is detected by the force sensor 12 when the lower jaw 8 and the upper jaw 7 are in position for locking the cup 4. In particular, the control lever 3 is instrumented by the force sensor 12.

In a nominal control mode, without breakdown, the lower jaw 8 and the upper jaw 7 are in the free position of FIGS. 1 and 2. The pilot uses the control stick 2 and the force feedback system, for example using a motor resolver, operates normally. In the event of breakdown in the mechanical chain connected to the control lever 3, the aircraft passes into a backup control mode by closing the lower jaw 8 and the upper jaw 7 in the locking position illustrated in FIGS. 3 and 4, the jaws blocking the cup 4 and conforming with its profile. A breakdown is for example a power supply fault on the force feedback motor.

The pilot then exerts a pressure on the control stick 2 to control: the force sensor 12 interprets the pressure to transmit the instruction to the control components. In a particular embodiment, the cup 4 has a torsional flexibility. The cup 4 is torsionally deformable under the effect of the force applied on the control stick 2 when it is manipulated, so that a force on the control stick 2 when the cup 4 is held by the jaws 7 and 8 opposes a force from the cup 4. The cup 4 thus simulates a specific force law.

This system is advantageous because it makes it possible to block the control stick 2 while eliminating the rest of the mechanics of the system. Thus, the aircraft comprises a backup control mode with its force feedback and its specific force law. In addition, the locking device 1 is compact, lightweight and easy to manufacture.

1. A control stick for a vehicle, the control stick comprising a control lever connected to a mechanical chain, a cup and a locking device, the control lever extending from a pivot point of the control stick, wherein the locking device comprises a frame, a lower jaw and an upper jaw which are movable between a locking position of the cup between the jaws and a free position, the lower jaw and the upper jaw being rigidly attached to the frame.

2. The control stick according to claim 1, wherein the cup is a sphere portion concentric to the pivot point and centred around the control lever.

3. The control stick according to claim 1, wherein the cup has a torsional flexibility and simulates a force law.

4. The control stick according to claim 1, wherein the control lever is movable according to a roll axis and a pitch axis orthogonal with one another, the roll and pitch axes able to be locked by the locking device.

5. The control stick according to claim 1, wherein the control lever is movable according to a yaw axis, the yaw axis being able to be locked by preventing rotation of the cup by the jaws of the locking device.

6. The control stick according to claim 1, comprising a mechanical actuator, actuating the jaws during a breakdown in the mechanical chain of the control stick.

7. The control stick according to claim 6, wherein the mechanical actuator comprises a spring and a means for releasing the spring, so that the jaws clamp the cup when the spring is released.

8. The control stick according to claim 1, comprising an electromagnetic actuator and a power supply of said electromagnetic actuator, the electromagnetic actuator actuating the jaws during a breakdown in the mechanical chain of the control stick.

9. The control stick according to claim 1, comprising a force sensor placed in series with the control lever so that an intention of a pilot of the vehicle is acquired when the jaws are in position for locking the cup.

10. A vehicle comprising a control stick according to claim 1.
